(19) United States
(12) Patent Application Publication
(10) Pub. No.: US 2019/0366480 A1
(43) Pub. Date: Dec. 5, 2019

(54) ADDITIVE MANUFACTURING WITH METAL WIRE

(71) Applicants: Abram Kotliar, Haifa (IL); Ziv Karni, Kfar Shemaryahu (IL)

(72) Inventors: Abram Kotliar, Haifa (IL); Ziv Karni, Kfar Shemaryahu (IL)

(21) Appl. No.: 15/996,635

(22) Filed: Jun. 4, 2018

(51) Int. Cl. B23K 26/342; B23K 26/03; B23K 26/06; B23K 26/067; B23K 26/08; B23K 26/12; B23K 26/14

(52) U.S. Cl. CPC B23K 26/342; B23K 26/03; B23K 26/0626; B23K 26/0643; B23K 26/0652; B33Y 30/00; B23K 26/0884; B23K 26/0861; B23K 26/123; B23K 26/1464; B23K 26/0676

(57) ABSTRACT

An additive manufacturing system includes an array of laser beams emanating from different directions and impinging upon a common focal spot. A feeder feeds a portion of a metal wire to the focal spot, and the laser beams combine to melt the portion of the metal wire to form a layer of metal on a support substrate. An actuator causes relative movement between the metal wire and the support substrate to create a 3D object from multiple layers of metal wire melted by the laser beams.

### FIELD OF THE INVENTION

The present invention generally relates to three dimensional (3D) printing or additive manufacturing of metal parts, and more particularly to an additive manufacturing system that melts metal wire to form metal parts.

### BACKGROUND OF THE INVENTION

Additive manufacturing (AM) methods include 3D printing techniques such as selective laser sintering or selective laser melting in which a 3D part is produced layer by layer by irradiating a powder bed of material with a laser beam. Selective laser sintering, such as Direct Metal Laser Sintering (DMLS), uses a laser to sinter material together. Selective laser melting (SLM) is similar but uses a laser to fully melt (rather than sinter) the material together, thus allowing for different properties such as crystal structure, porosity and the like. SLM produces parts from a single metal, while DMLS can produce parts from metal alloys.

There are additive manufacturing methods that make parts from metal wire. One example is Electron Beam Additive Manufacturing (EBAM), developed by Sciaky Inc. EBAM is a type of soldering process, where a very powerful electron beam is used to fuse a metal wire (usually titanium) and the molten metal is shaped into a metal structure. The electron beam is used in a vacuum chamber. The electron beam gun deposits metal, via the wire feedstock, layer by layer, until the part reaches near-net shape, and then afterwards undergoes finish heat treatment and machining.

Another example is Rapid Plasma Deposition (RPD) technology by Norsk. Titanium wire is melted with plasma torches in an inert atmosphere of argon gas and precisely and rapidly built up in layers to a near-net-shape part. Two plasma torches are used, one to pre-heat the substrate or prior layer, and the other to melt the titanium wire quickly and precisely. No vacuum chamber is required for RPD; the process takes place in an argon environment similar to standard TIG (tungsten inert gas) welding.

Another example is Laser Metal Deposition-wire (LMD-w), in which a metal wire is fed through a nozzle and is melted by a laser. The process is carried out with inert gas shielding in an open environment (gas surrounding the laser), or in a sealed gas enclosure or chamber. LMD-w uses a robot-manipulated laser to melt the surface of a titanium substrate, creating a localized pool of molten titanium into which titanium wire is fed to form a bead. Also using robotics, the melt pool is manipulated along a 3-D path to create a net-shaped (or near-net-shaped) part, bead by bead, onto the substrate in layers.

SLM and DMLS have disadvantages in comparison to the metal wire techniques. The powdered metal used in SLM or DMLS is specially made and very expensive. The volume of powder needed to make the part can be five times greater than the volume of the finished part. The majority of the material is not used, and must be reclaimed or discarded. Powder has safety issues. Breathing in fine particles can be harmful so breathing apparatuses and ventilation must be used. In addition, some powders are highly flammable, like aluminum or titanium, and some are toxic. AM parts made from metal wire typically have superior strength compared to parts made from powder-based processes.

However, the prior art wire-based techniques also have disadvantages. AM parts made from metal wire may suffer from residual stress and distortion due to excessive heat input. They may also have relatively poor part accuracy and poor surface finish, due to the layer thickness of the wire-feed AM technology.

### SUMMARY OF THE INVENTION

The present invention seeks to provide a novel and improved additive manufacturing system and method in which metal wire is melted to form metal parts, as described in detail below. The system and method do not have the abovementioned disadvantages of the prior art.

In an embodiment of the invention, high-power laser beams, emanating from multiple directions (e.g., 2-6 or more directions), are directed to a single focal spot on a metal wire. The metal wire may be fed to the focal spot with a wire feeder or other actuator. The tip of the metal wire is maintained at the focal spot of the multi-beam laser. A single laser may be the source of the multiple beams: the single beam emitted by the laser is reflected by reflectors into multiple beams which impinge upon the common focal spot from different directions. This arrangement enables moving the laser beams together to any three-dimensional direction with the same effectivity.

For example, without limitation, a laser beam with a 0.5-10 KW output may be used with a pyramid reflector which reflects the single laser beam into three to six directions (e.g., spaced 120°-60° from each other). Parabolic or other kinds of mirrors may be used to direct and focus the laser beams to the common focal spot at working angles of 5-75°, without limitation. The wire may be fed from a wire feeder at the center of the laser beam array.

For example, without limitation, in the case of a fiber optics laser, the laser spot size diameter can be varied by moving the position of the exit pupil of the fiber optics (e.g., without limitation, 100 or 200 μm in core diameter with numerical aperture (NA)=0.22). In this manner, the laser beam can be modified to adapt to different wire materials and different wire diameters. As another option, the system may include a laser beam (from the same laser source or different sources) to pre-heat or post-heat the material, for example, to release tension or for metallurgical reasons.

The invention can use wires made of single or multiple metals, or wires of different diameters (e.g., without limitation, 100 μm to 5 mm), thereby providing manufacturing flexibility not attainable in the prior art. The method of the invention is not limited to part size or metal material. The method is significantly less expensive than prior art systems.

In one embodiment of the invention, the thermal or electrical contact between the metal wire and the support surface may be measured and monitored with sensors. The sensed information may be used to control the laser beam characteristics or the temperature of the metal wire in order to achieve required properties of the printed part. For example, the temperature measurement may be used in a closed loop control system to change the laser energy at different portions of the parts being created.

There is thus provided in accordance with a non-limiting embodiment of the present invention an additive manufacturing system including an array of laser beams emanating from different directions and impinging upon a common focal spot, a feeder configured to feed a portion of a metal wire to the focal spot, the laser beams combining to melt the portion of the metal wire to form a layer of metal on a support substrate, and an actuator configured to cause relative movement between the metal wire and the support substrate to create a 3D object from multiple layers of metal wire melted by the laser beams.

In accordance with a non-limiting embodiment of the present invention the laser beams include beams split from another laser beam, that is, the beams could be split from a single laser beam source or from different laser beam sources. The portion of the wire may be located at a center of the array of laser beams. The embodiment may use wires of different size diameters and/or wires made of different metals.

In accordance with a non-limiting embodiment of the present invention at least one beam modulator modulates the laser beams so as to modify a size of the focal spot.

The angle at which the laser beams impinge upon the focal spot may be in a range of 5-75°. The power of the laser beams may be in a range of 0.5-10 KW.

In accordance with a non-limiting embodiment of the present invention a sensor senses electrical conductivity and/or thermal conductivity of metal wire melted by the laser beams, the sensor being in operative communication with a controller configured to control a parameter of the laser beams, or a thickness of any of the layers, in accordance with information sensed by the sensor.

In accordance with a non-limiting embodiment of the present invention the actuator may include an XYZ table, a rotating and/or tilting table, or a multi-axis robot arm.

### BRIEF DESCRIPTION OF THE DRAWINGS

The present invention will be understood and appreciated more fully from the following detailed description, taken in conjunction with the drawings in which:

FIG. 1 is a simplified illustration of an additive manufacturing system, constructed and operative in accordance with a non-limiting embodiment of the present invention; and

FIG. 2 is a simplified illustration of a part being made with the additive manufacturing system and also showing sensors which may be used to control the system.

### DETAILED DESCRIPTION OF EMBODIMENTS

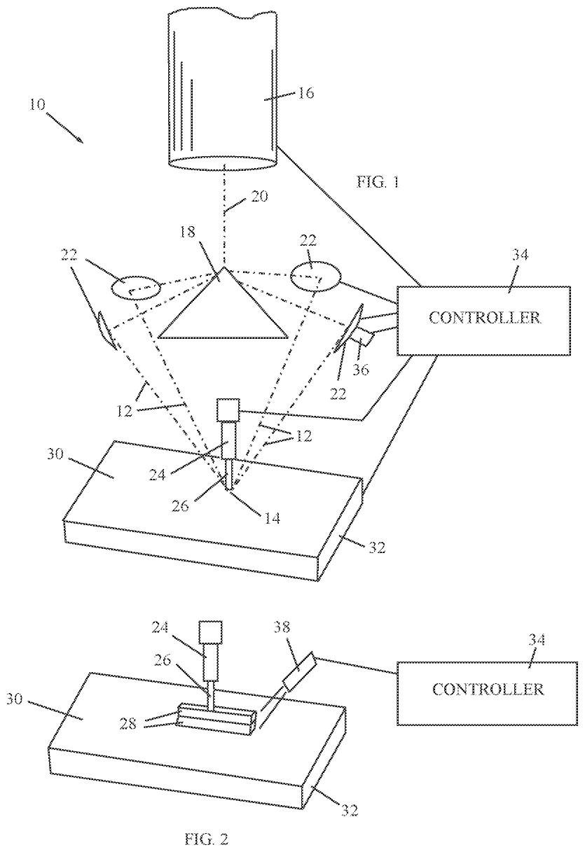

Reference is now made to FIG. 1, which illustrates an additive manufacturing system 10, constructed and operative in accordance with a non-limiting embodiment of the present invention.

The additive manufacturing system 10 may include an array of laser beams 12 emanating from different directions and impinging upon a common focal spot 14. Without limitation, a single laser beam source 16 is used to generate the array of laser beams 12. For example, a fiber-optics laser 16 with a 0.5-10 KW output may be used with a pyramid reflector 18 which reflects a single laser beam 20 into multiple beams 12 (four are shown here, but other amounts may be used as well, spaced equally or non-equally from each other). Parabolic or other kinds of mirrors or other kinds of reflectors 22 may be used to direct and focus the laser beams 12 to the common focal spot 14 at working angles of 5-75°, without limitation.

A feeder 24 is arranged to feed a portion of a metal wire 26 to the focal spot 14. Feeder 24 may be located at the center of the laser beam array, but can be located to the side of the array or other locations, too. Positioning the wire vertically at the center of the laser beam array is advantageous because the wire is heated symmetrically and the molten metal is uniformly at the same temperature so that the molten metal is isotropic (same material properties in all directions). If the metal were not vertical, it is more difficult if not impossible to achieve isotropic properties. The laser beams 12 combine to melt the portion of the metal wire 26 which is at the focal spot 14 to form a layer of metal 28 (FIG. 2) on a support substrate 30. The support substrate 30 may be pre-formed or may be formed with the additive manufacturing system 10 as part of the part being manufactured.

An actuator 32 causes relative movement between the metal wire 26 and the support substrate 30 to create a 3D object from multiple layers 28 (FIG. 2) of metal wire 26 melted by the laser beams 12. Actuator 32 may include an XYZ table, a rotating and/or tilting table, or a multi-axis robot arm or other suitable devices.

Numerous layers of metal can be deposited and machined to form complex 3D metal parts that have exact tolerances. The same CAD (computer-aided design) software that was used to design the part may be used as the database for a controller 34 that controls the movement of the actuator 32.

As seen in FIG. 1, a beam modulator 36 may be used to modulate the laser beam 12 so as to modify a size of the focal spot 14. (For simplicity, only one beam modulator 36 is shown in FIG. 1, but it is understood that beam modulators may be used with all or some of the laser beams, the main laser beam or reflected beams.)

For example, without limitation, in the case of a fiber optics laser, the laser spot size diameter can be varied by moving the position of the exit pupil of the fiber optics (e.g., without limitation, 100 or 200 μm in core diameter with numerical aperture (NA)=0.22). In this manner, the laser beams 12 can be modified to adapt to different wire materials and different wire diameters. For example, it is possible to combine two or more different metal alloys from two or more different metal wire feeds into a single melted bead at the focus spot 14, with the feed rates and laser beam characteristics controlled by controller 34, which is in operative communication with the laser 16 (and/or reflectors 22), actuator 32, beam modulator(s) 36, and feeder 24. In this way, it is possible to change the mixture ratio of the different materials, or to alternate between different wire gauges for finer deposition features (thin wire) and gross deposition features (thick wire).

As seen in FIG. 2, one or more sensors 38, in operative communication with controller 34, may be used to sense electrical or thermal conductivity of metal POOL melted by the laser beams. In this manner, controller 34 can control parameters (e.g., power, duration, and others) of the laser beams in accordance with information sensed by the sensor 38. The sensed information may be used to control the laser beam characteristics or the temperature of the metal wire in order to achieve required properties of the printed part. For example, the temperature measurement may be used in a closed loop control system to change the laser energy at different portions of the parts being created.

The sensors can be non-contact sensors (e.g., optical or other non-contact electrical conductivity sensors, pyroelectric sensors or thermal radiation sensors) or may be contact sensors (e.g., capacitance or inductance sensors, thermistors, thermocouples, etc.).

As another option, the system may include a laser beam (from the same laser source or different sources) to pre-heat or post-heat the material, for example, to release tension or for metallurgical reasons.

What is claimed is:

1. An additive manufacturing system comprising:
an array of laser beams emanating from different directions and impinging upon a common focal spot;
a feeder configured to feed a portion of a metal wire to said focal spot, said laser beams combining to melt said portion of said metal wire to form a layer of metal on a support substrate; and
an actuator configured to cause relative movement between said metal wire and said support substrate to create a 3D object from multiple layers of metal wire melted by said laser beams.

2. The system according to claim 1, wherein said laser beams comprise beams split from another laser beam.

3. The system according to claim 1, wherein said portion of said wire is located at a center of the array of laser beams.

4. The system according to claim 1, wherein said portion of said wire is located vertically at a center of the array of laser beams and is heated symmetrically.

5. The system according to claim 1, wherein said wire comprises wires of different size diameters.

6. The system according to claim 1, wherein said wire comprises wires made of different metals.

7. The system according to claim 1, further comprising at least one beam modulator configured to modulate said laser beams so as to modify a size of said focal spot.

8. The system according to claim 1, wherein an angle at which said laser beams impinge upon said focal spot is in a range of 5-75°.

9. The system according to claim 1, wherein a power of said laser beams is in a range of 0.5-10 KW.

10. The system according to claim 1, further comprising a sensor configured to sense electrical conductivity of metal wire melted by said laser beams, said sensor being in operative communication with a controller configured to control a parameter of said laser beams, or a thickness of any of said layers, in accordance with information sensed by said sensor.

11. The system according to claim 1, further comprising a sensor configured to sense thermal conductivity of metal wire melted by said laser beams, said sensor being in operative communication with a controller configured to control a parameter of said laser beams, or a thickness of any of said layers, in accordance with information sensed by said sensor.

12. The system according to claim 1, wherein said actuator comprises an XYZ table or a rotating and/or tilting table.

13. The system according to claim 1, wherein said actuator comprises a multi-axis robot arm.
